(19) United States
(12) Patent Application Publication
(10) Pub. No.: US 2004/0021549 A1
(43) Pub. Date: Feb. 5, 2004

(54) System and method of providing and autheticating works and authorship based on watermark technique

(76) Inventors: Jong-Uk Choi, Seoul (KR); Won-Ha Lee, Seoul (KR)

Correspondence Address: Stephen M De Klerk, Blakely Sokoloff Taylor & Zafman, Sventh Floor, 12400 Wilshire Boulevard, Los Angeles, CA, 90025, US

(21) Appl. No.: 10/311,031

(22) PCT Filed: Jun. 11, 2001
(86) PCT No.: PCT/KR01/00997

(30) Foreign Application Priority Data
Jun. 10, 2000 (KR) 2000/31945

(51) Int. Cl. G06F 7/04

(52) U.S. Cl. 340/5.8; 705/57

(57) ABSTRACT

The supply of works of authorship and their authentication are provided by a service system and method for supplying and authenticating digital data works of authorship based on a watermarking system. The works of authorship including invisible information on a copyright is provided through this system. In the event that illegal use of original works of authorship is sensed, the illegal copy and use of multimedia contents could be prevented by presenting accurate technical evidence to support the information on a copyright through authentication of an authentication organization and thereby the protection of a copyright is possible. Authentication of a copyright of the contents is performed by the steps of imbedding and extracting of a digital watermark such as a logo or signature of a copyright holder on a data.

### TECHNICAL FIELD

The present invention relates to a service system and method for supplying and authenticating a copyright based on a method and device, in which a watermark is embedded into the data of a digital content (digital image, digital audio, digital video, digital document, etc.) and the embedded watermark is extracted. More particularly, this invention relates to a service system and method for supplying and authenticating a copyright, which are capable of protecting a copyright of original data by selling or providing data, in which copyright information is hidden in an image watermark form, to users on the internet, and settling copyright-involved distribution by using an authentication result from a comparison of information extracted from the hidden copyright information with the copyright information previously registered in a certificate authority, thereby preventing illegal copying and distribution of the data.

### DESCRIPTION OF PRIOR ART

With the recent rapid spread of internet services, the population of internet users in Korea reached 14.8 millions as of the end of 1999. Under such circumstances of sharp growing Internet, presently, information such as text, still images and simple moving pictures is mainly in distribution. However, owing to the spread of various forms of video/audio transmission media, internet transmission of all sorts of multimedia data is on an increasing trend.

Meanwhile, it is believed that papers, magazines, audio, radio, TV programs, and electronic libraries presently being operated free on the internet will be converted to chargeable services in the future. Domestic content providers are pushing forward chargeable services of contents centering on small payment service companies and PC telecommunication companies. According to such tendency, providers of digital information or content owners will need to assert and protect their copyrights on the information (digital copyrighted materials such as images, audio, video, etc.) they own, and request a reasonable compensation for use in the case of providing their copyrighted materials to others.

However, digital copyrighted materials have so many problems in their copyrights protection in view of their features. Since desired information could be easily stored or converted, multiple copies of information are possible without constraint in a free-accessible space like the internet. Further, even after copying, there can be maintained the same data information as that of the original, moreover, its distribution is possible without a copyright owner's consent, and thus copyright protection of a copyright owner is difficult.

As such, copyright infringements are increasing day by day, many legal, systemic and technical resolutions to solve these problems have been formulated. For this purpose, there are provided certain technical solutions, such as encryption of data by which an encrypted data is available to only a specific user and a digital watermarking technique where copyright information is hidden in data, which data is then transmitted to a user without the data being deformed outwardly.

Among these technical solutions, as a watermarking is a copyright protection technique of digital data, it can be considered a copyright indication or verification technique for a digital content. This technique makes it possible to detect counterfeit or alteration of data and assert the ownership of a copyright holder by hiding copyright information in data and extracting again the hidden copyright information.

As watermarking embedding methods, there are provided a Spatial Method in which a subtle transformation is applied to data such as pixels of a screen and the like to be used as a watermark; Discrete Cosine Transform (DCT) in which digital-type data are converted to analog signals of frequency components and then a watermark converted by the same method is embedded; Fast Fourier Transform (FFT); and a Frequency Domain Method using wavelet transform.

A watermarking technique adopted by the present invention for copyright protection is to embed a “mark” which protects the original information. Such method is divided into a visible watermarking technique perceptible to the human eye and an invisible watermarking technique imperceptible to the human eye.

As the visible watermarking technique is a type of overwriting copyright information on the original, it generally prevents a user from illegally eliminating the copyright information. However, since the copyright information is visually displayed on the original, it has a disadvantage that it is difficult to preserve the value of the original. The visible watermarking technique is technically realizable without difficulty but it damages the content, thus making it difficult to be used in the electronic business.

In contrast, since the invisible watermarking technique is invisible to the human eye, it can protect a copyright without damaging the original. Also, in case that a copyright-related problem occurs, a copyright holder can claim his copyright based on the copyright information extracted from the original. Currently most watermarking techniques employ this invisible method. Accordingly, in case where the invisible watermarking technique is used, even if images or audio/video files are distributed across the internet, users could not perceive at all whether a watermark is embedded in the copyrighted material distributed. Even a copyright holder who embedded a watermark could not find the difference between a file before the watermark is embedded and that after the watermark is embedded.

Conventional methods for embedding/extracting a watermark are directed to “a watermarking method based on detection” that embeds a user's ID (number, name) or simple data into a copyrighted material and detects them. In such an image watermarking method, presently, the existence of a watermark is determined by measuring a correlation between a watermark-embedded image and a user ID after embedding a user ID composed of 48 bits or so binary codes into image data. That is, if the correlation coefficient shows 0, the data is determined not to include the user ID, however, if the correlation coefficient shows values other than 0, the data is determined to include the user ID. Digimarc, BlueSpike, MediaSec and AlphaTech, etc., that are now providing a watermarking technique of the image field, generally use the above method.

However, under the present circumstances that embedding or detecting work of a specific ID as a watermark is performed directly by users, a big problem is how to establish a copyright on the relevant copyrighted material or settle such dispute in the event that copyright-related disputes arise.

Also, even in a case where copyrighted material is distributed through a legal course, there is a problem such that a copyright owner could not know the extent of the use and detection of such watermark is completed.

Furthermore, even if a watermark on a copyrighted material is embedded, since such embedment is merely performed by either a user or a copyright holder but does not contain information on the copyrighted material according to its characteristics, it is impossible to find out a distribution channel of such copyrighted material.

Also, since the aforementioned methods use a method for embedding information that has no direct relationship with a copyright as binary code, there has a limitation that it is not easy to obtain information about a copyright from copyrighted material containing an embedded watermark.

### SUMMARY OF THE INVENTION

It is therefore an object of the present invention to overcome the above-described problems in prior art. In order to protect a copyright of digital multimedia data distributed on the internet, there is provided a service system and method for supplying and authenticating copyrighted materials by providing a service capable of verifying user information using a watermark embedding and extracting method based on extraction.

It is another object of the present invention to provide a system and method for protecting a copyright of a content provider (i.e., a copyright holder, and a seller to whom a duplication right of copyrighted material is assigned from the copyright holder) by embedding a watermark including user information into various digital content data and then distributing the content containing a copyright on the internet.

It is another object of the present invention to provide a means capable of verifying and authenticating an original by applying this technique to electronic documents exchangeable on the internet (various administrative civil affair documents, contracts, principle documents of companies, electronic publications, receipts, purchasing documents, etc.) in order that parties can safely exchange electronic documents on the internet.

It is another object of the present invention to establish the just internet business culture by preventing the loss of information and the distribution of illegally copied data on the internet, which is possible by embedding main information into digital data in a watermark form and then transmitting it.

It is another object of the present invention to discover a distribution channel of the corresponding copyrighted material by transmitting copyright-related information which is embedded as a watermark after sorting the information on a copyright holder and users.

In order to achieve the above-mentioned objects, the service system for supplying copyrighted material according to the present invention includes a database for storing information on a copyrighted materials, and a copyrighted material supplying means for supplying the copyrighted material, at a user's request through the internet, into which copyright information is embedded as a watermark, said copyrighted material being received from said database.

Further, the service system for authenticating a copyrighted material according to the present invention includes a database for storing information on the copyrighted material, and a copyrighted material authenticating means for performing authentication on the copyrighted material supplied from a user, at the user's request through the internet, after comparing on extracted watermark embedded in the copyrighted material of said user with the information on said copyrighted material stored in said database.

The service method for supplying a copyrighted material according to the present invention includes a step of registering a copyrighted material supplied by a copyright holder through the internet and copyright information of said copyrighted material; a step of embedding said copyright information into said copyrighted material as a watermark at a user's request for the supply of said registered copyrighted material; and a step of providing the watermark-embedded copyrighted material to said user.

The service method for authenticating a copyrighted material according to the present invention includes a step of receiving a copyrighted material at a user or copyright holder's request through the internet for the authentication of the copyrighted material; a step of extracting a watermark from said received copyrighted material; and a step of transmitting the authentication result to said user or copyright holder after comparing the copyright information obtained from said extracted watermark with stored copyrighted material and copyright information.

Hereinbelow, the service system and method for supplying/authenticating copyrighted material based on the watermarking technique according to the present invention will be more concretely explained with reference to the accompanying drawings.

### BRIEF DESCRIPTION OF THE DRAWINGS

FIG. 1 is a block diagram schematically illustrating the constitution of a system, which supplies a copyright authentication service on digital data according to the present invention.

FIG. 2 is a block diagram, showing an instance of the service supplying system according to the present invention, which illustrates the constitution of the system, being divided into server/client sides, for supplying a watermark embedding service.

FIGS. 3A and 3B are flowcharts illustrating one embodiment of the operation method in a service supplying system according to the present invention. FIG. 3A illustrates a process for embedding a watermark and FIG. 3B illustrates a process for extracting a watermark.

FIG. 4 illustrates an instance in case where a user is allowed to select a watermarking method during a process of FIG. 3A.

FIG. 5 is a flowchart schematically illustrating a process for embedding/extracting a watermark by using various watermarking methods provided by MDCAS.

FIG. 6 is a flowchart schematically illustrating a process in which a user is allowed to directly embed a watermark and to register the watermark-embedded content in MDCAS.

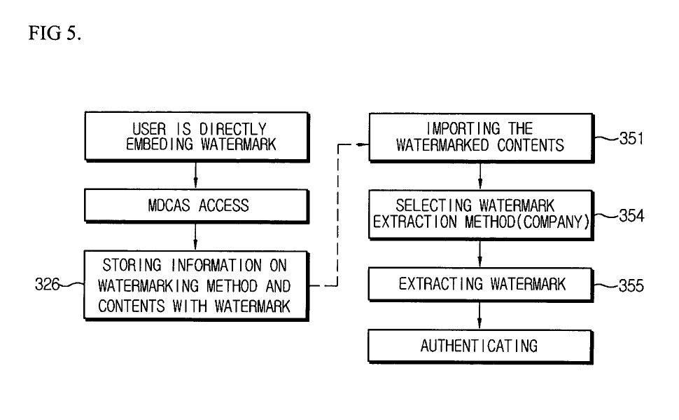

### DETAILED DESCRIPTION OF THE PREFERRED EMBODIMENTS

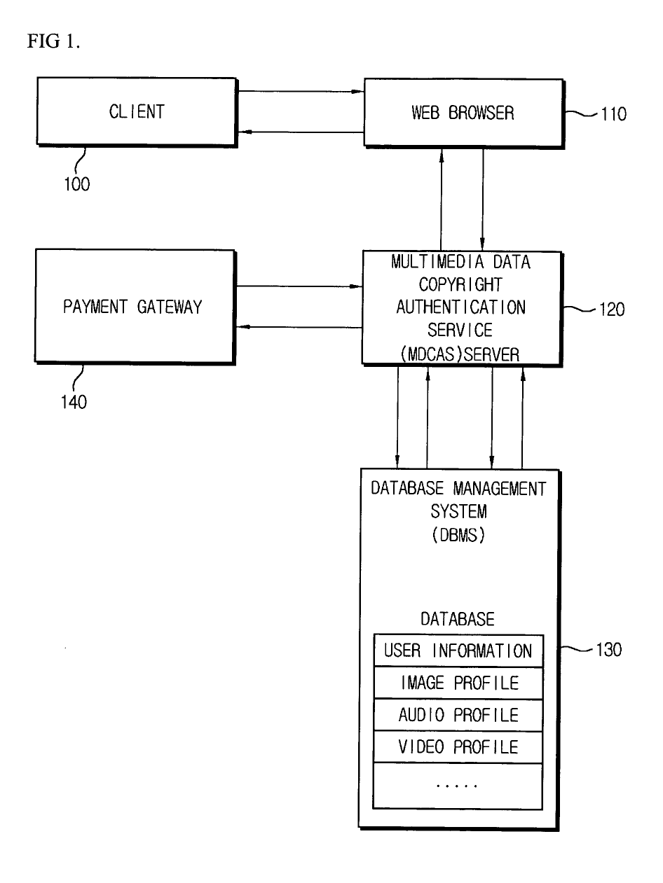

FIG. 1 is a block diagram, which schematically illustrates the constitution of a system for supplying a copyright authentication service on digital data according to the present invention. The system of FIG. 1 includes a user system (a service requester/a user; hereinafter referred to as ‘client’) 100 to be accessed via the internet, a multimedia data copyright authentication server (hereinafter referred to as “server”) 120 for supplying Multimedia Data Copyright Authentication Service (hereinafter referred to as MDCAS); and a web browser 110 which plays a role as an intermediary of data communication between a DataBase Management System (hereinafter referred to as DBMS) 130 for storing information about the user information and various multimedia data, and a server 120 and a client 100. Said system may include a Payment Gateway 140 for surcharging on the use of the multimedia data.

According to the system of the present invention, the supply of copyrighted material of digital data or the copyright authentication is performed in the client 100 and the server 120 as a certificate authority of the digital data copyright. The above client 100 means all systems of copyright holders who allow users to utilize their copyrighted materials by making their copyrighted materials authenticated by means of the MDCAS or by registering their copyrighted materials in the database management system, as well as users who are supplied with the copyrighted materials by using the MDCAS.

Also, for the watermarking technique used in the above system, conventional various watermarking methods are available. Also, there are available methods taught by a watermarking-related patent application filed by the applicant of the present application (Korean Patent Application No. 98-37237: Watermarking method of digital image using wavelet conversion and discrete cosine conversion; Korean Patent Application No. 37274: Watermarking method of digital image using wavelet conversion and discrete cosine conversion).

In the present invention, “an extraction-based watermarking method” will be exemplified, which is used in the above-mentioned earlier patent applications and in which an imaged watermark is embedded into the original data and then extracted. In the case of image data, the extraction-based watermarking method capable of identifying the embedded watermark after extraction with the human eye has more commercial value, rather than “a detection-based watermarking method” in which a watermark is embedded by generating a conventional random sequence, i.e., a method of determining only the embedment of a watermark by calculating a co-relationship.

In other words, since the extraction method uses symbols, such as a trademark, logo, registered seal, emblem, or an autograph already publicly authorized or known to the public, as an authentication means, the extraction method is much easier to protect and identify a watermark than the detection method using binary codes. However, the watermarking method is not limited to such method but various methods to be determined by a content holder are available as mentioned above.

In case that it is determined to be necessary to extract and authenticate copyright information for accurate evidence, the extraction-based watermarking method to be given as an example in the present invention may be used. However, for the case of determining only whether or not a watermark exists, the detection-based watermarking method may be used, in which a random bit sequence occurred by using a key (a specific key or user key) is used as a watermark. That is, there are various watermarking methods that have been developed or are presently being developed as described above, and thus a content holder can select a method suitable for his circumstance or business. However, such developed methods are quite different from each other and their purposes to be sought also considerably differ and thus, it is now difficult to mutually endorse such methods and manage a standardized content.

In order to overcome such problems, there is recently provided a two-layer digital watermarking method. Said two-layer digital watermarking method uses a mixture of a selective watermark (called as “real watermark”) and a standard watermark (called as “meta watermark”), meaning a mixed use of a meta watermark and a real watermark.

For example, it means that specific indexes provided in each of the watermarking methods are embedded into a meta watermark of 8 bits (watermarking method for company A is No. 1, and that for company B is No. 2, etc.), information of each content or information of a copyright holder, etc., can be selectively and freely embedded into a real watermark of 16 bits. That is, this method detects what watermarking technique is used from extraction of a meta watermark, and then, selects an extraction method therefrom to detect a real watermark. The present invention may also use the above two-layer digital watermarking method in selecting a watermarking method for an authorization service.

In the system according to the present invention, there are provided two services for supplying and authenticating a copyrighted material. As one service is embedding copyright information, it can simply embed copyright information into the original data as well as store in a certificate authority such information when a user registers the embedded data in the certificate authority and whether the copyright authentication (embedment of a watermark) is completed, thereby capable of issuing authentication data containing such information at any time when the user requests it. Also, this service makes it possible to find out a distribution channel of a copyrighted material by hierarchically embedding copyright information depending on whether a user is a copyright owner of the relevant copyrighted material or a simple user utilizing the copyrighted material.

The other service is authenticating copyright information of data by detecting and extracting a watermark from watermark-embedded data.

Examining the detailed operation of such services according to the foregoing basic characteristics, a client 100 connected to a server 120, the certificate authority, exchanges data through the web browser 110 on the internet. The server 120 receives the inputted specific data through the web browser 110 from the client 100, and then, stores the data in the database within the DBMS 130 or retrieves the database to transmit the requested data to the client 100 through the web browser 110. The database within the DBMS 130 of the certificate authority is divided into a variety of tables, for example, user information, image profiles audio profiles and video profiles, etc. The user information table stores matters for proving a person's identity, such as a user's name, ID, password, address, identification number, as well as matters about payable means in the case of using a copyright authentication service (payment method, type of cards, card number, and term of validity, etc.).

Such user information table can be classified into copyright holder information containing a content copyright and content provider information. A person who wishes to be a member of the early stage should input the above-mentioned all his user information, which is stored in the database.

A registered member, whose all user information is stored in the database, should log in by using his ID and password. That is, in case where a registered member uses the authentication service in the future, the server 120 requests the DBMS 130 to verify the user information. Then, ID and password inputted by the user are transmitted to the database in the DBMS. In this case, according to the consistency or inconsistency of the information stored in the database and the information inputted, the result is transmitted to the server 120 and outputted to the user though the web browser 110.

Also, when a service is used, a service charge is paid by a registered payment means among the stored user information. For this purpose, in case where a user utilizes a service of the present invention, the authentication system of the present invention comprises a means for transmitting an itemized use statement to the payment gateaway 140 so that the user can pay his service charge. In addition, in order to provide the system of the present invention on the web, it is desirable that a united platform interface such as an ActiveX control be provided to a user utilizing MDCAS.

For a watermark embedding method for providing copyrighted material for which a copyright is authenticated, there are provided a case where a watermark embedding process is performed by a user and an other case where the watermark embedding is performed by a certificate authority at a user's request. First, in the case of watermarking by the certificate authority, if a user transmits the original copyrighted material to the certificate authority (via on-line or off-line), then the certificate authority embeds a watermark image including a user's logo requested into the original copyrighted material and then transmits the watermark-embedded data to the user. Regardless of the place of watermarking, the user can distribute the watermarked data, not the original copyrighted material, on the internet.

For the performance of a watermarking by the certificate authority, a user should first register himself or his logo with the certificate authority. The processes of membership registration and logo registration will be needed in the future when providing a service for extracting a watermark from a watermark-embedded copyrighted material, and which are a registration procedure for authenticating a copyright. A logo of the present specification can be used as an identifier of a user such as an individual signature or a company's logo, and thus it is desirable that the logo be easily recognizable in the form of images. Therefore, it is desirable that a watermark to be embedded into a copyrighted material include a logo image together with additional information.

Likewise, in case where a user directly embeds a watermark, the user must register himself as a member along with registration of his logo. As stated previously, this is because such registration process bears a meaning as a procedure for registering a copyright at the authenticate authority. A copyright authentication service for the case of a user's direct embedding of a watermark is also divided into to two cases. One is that both the generation of a logo and the embedment of a watermark are performed by a user. The other is that a logo is generated by the MDCAS and a watermark is embedded by the user.

In the first case, the MDCAS is not involved but a user performs both the generation of the logo and the embedment of the watermark. However, as stated above, even in the case that the user wishes the authentication of a copyright of the original copyrighted material by the certificate authority, the user must register the original, a logo, and data containing the copyright information in the certificate authority. In this case, the user can protect his copyright by the certificate authority by recording information about the entrance and registration dates in the certificate of authority.

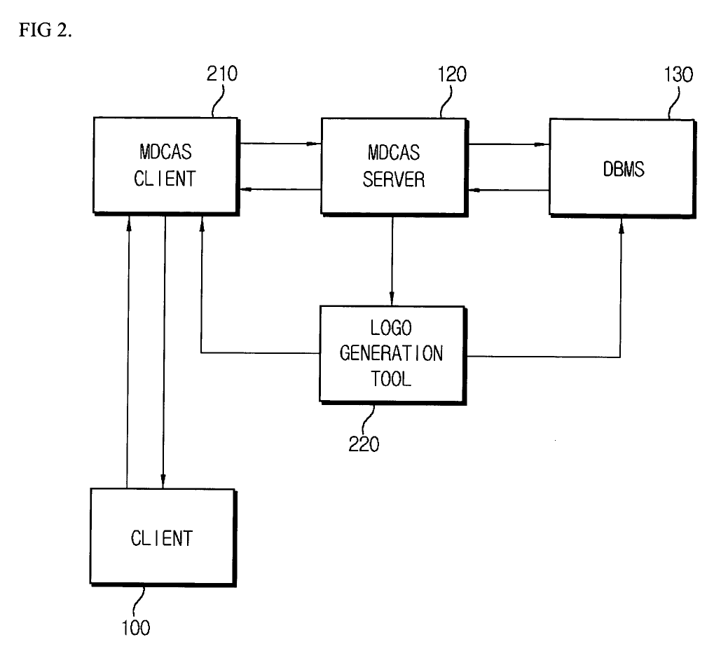

In the second case, the client 100 generates his own logo by using the MDCAS server 120 and embeds it into the original copyrighted material, the constitution of which will be explained below with reference to FIG. 2.

FIG. 2 is a block diagram, as an example of a service supplying service according to the preset invention, which illustrates the constitution of a system divided into server/clients sides for providing a watermark embedding service. Unlike the constitution of FIG. 1, the constitution of FIG. 2 additionally includes a logo generation tool 220 enabling a user to generate a logo, and a MDCAS client 210 enabling a client 210 to operate the logo generation tool.

The following is the operation of the above constitution. First, the client 100 accesses the MDCAS server 120 by using a private ID and password given from becoming a member of the MDCAS server 120. A user requests the MDCAS server 120 to generate a logo to be used for his copyrighted material. The server 120 provides a tool for generating a new logo of the client 100, i.e., the logo generation tool 220. The logo generated therefrom is provided to the client 100 via the MDCAS client 210, simultaneously being stored in the database within the DBMS 130.

The client 100 receives the generated logo and then embeds it into the original copyrighted material by using the MDCAS client 210. The MDCAS client 210 existing between the client 100 and MDCAS server 120 is a kind of a virtual system model for a series of operation (watermark embedding operation) to be performed in the client 100. If the client 100 registers the logo in the certificate authority, then the MDCAS server 120 transmits to the client 100 messages as follows: “You should install a plug-in for using a watermark embedding service. Will you install?” If a user selects “YES” in response to this message, a program for the MDCAS client 210 is downloaded from the MDCAS server 120 and then installed in an information processing device of the client 100. If the capacity of the server 120 or its processing speed is excellent and thus there is no concern of extra-loading, it is possible to provide a watermark embedding service in the server without using the MDCAS client program.

Also, in case where a user simply requests the use of copyrighted material stored in the DBMS 130, he should make a request the use of a specific copyrighted material of the MDCAS server 120 without realizing the MDCAS client 210 or logo generation tool 220. Then, the MDCAS 120 embeds the previously registered user information as a watermark by using a watermarking technique of a predetermined method and then transmits the information embedded to the user, i.e., client 100. In this case, the information on the copyrighted material, such as information about a copyright holder and his logo, is embedded as a basic watermark and information about a user who utilizes such copyrighted material, such as the time that the use of the copyrighted material is requested and personal information about the scope of the use and users, is embedded as a watermark. That is, information about a copyright holder and a user are hierarchically embedded, thereby it is possible to easily grasp a distribution channel of the copyrighted material.

According to another aspect of the present invention, a watermark is extracted from the watermark-embedded copyrighted material to verify and authenticate the copyright information, which is an essential step for a case where an illegal use of the copyrighted material is sensed and thus there arises a dispute between the original copyright holder and an illegal user. When such dispute arises, the certificate authority can authenticate a copyright of the original copyright holder by presenting evidencing materials such as “a certificate of authentication”, which contains the registration date and information about a copyright holder and a copyright. At this time, if a user embeds a watermark, both the original data and doubtful data of illegal use are sent to the certificate authority for extracting a watermark embedded in the illegal data. The certificate authority authenticates a copyright after comparing the watermark extracted from the doubtful data with registered individual information and logo data.

In case that copyright information is embedded by the certificate authority, since there exist previously registered individual information and data such as original data and logo in the certificate authority, only the doubtful data of illegal use is sent to the certificate authority. Thereafter, the certificate authority extracts a watermark using the original stored in the database, and then, authenticates a copyright by means of comparison of the doubtful data with the copyright information such as a watermark and logo extracted.

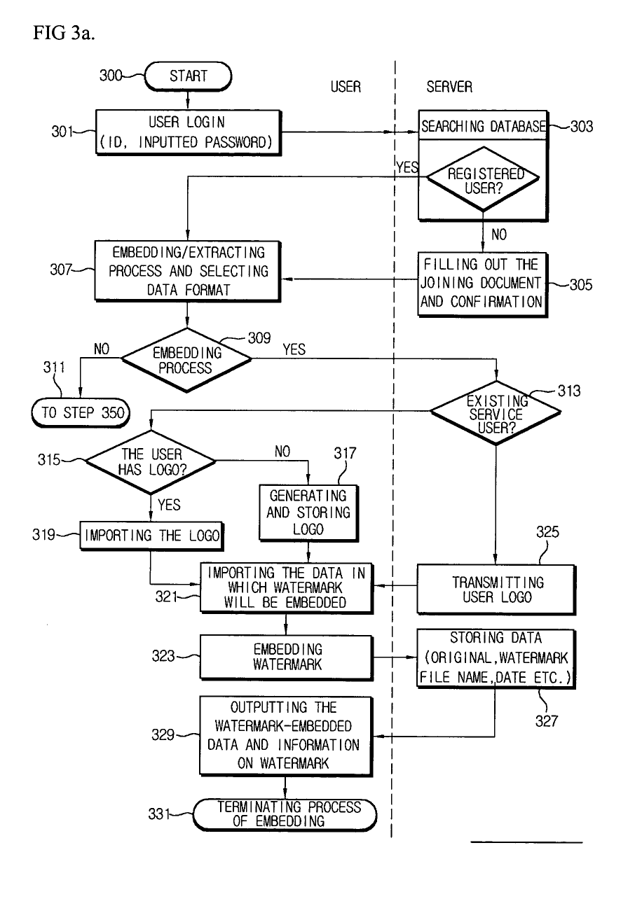

FIGS. 3A and 3B are flowcharts illustrating an embodiment of the operation method in a service supplying system according to the present invention. FIG. 3A illustrates a process of embedding a watermark and FIG. 3B illustrates a process of extracting a watermark. The basic flow in the above flowcharts is as follows: First, a user requests an access service of the certificate authority by using his registered private ID. If the ID is not registered, the user should take a step for registering the ID in the certificate authority. The user selects the type of service (copyright information embedment, copyright information extraction) and requests the corresponding service. The server transmits individual user information to DB, confirms it and executes the operation requested. FIGS. 3A and 3B are flowcharts, which illustrate in detail the divided user/server sides of the MDCAS process supported on the internet web browser.

First, the process of embedding a watermark of FIG. 3A among the above entire processes will be reviewed. In order to use the copyright authentication service supplying system according to the present invention, a user accesses the internet to access a homepage providing the present service. Then, the user logs in a service system through a login browser which is outputted to the web browser (step 301).

User information is obtained from the database on the database management system 130 based on the user's ID and password inputted during the login process and then determines whether or not the user is registered (step 303). In the case of a new user, he inputs information on his personal information and payment method to be stored as the user information and then goes through the necessary steps to confirm the inputted information (step 305).

If the user is confirmed, the authentication service is begun. In the authentication service, a process of embedding/extracting a watermark and a data format to be embedded as a watermark (for example, image size) are selected (step 307). If a service selected is a process of extracting a watermark, then it is proceeded to step 330. However, if it is a process of embedding a watermark, then it is checked whether the user is an existing service user (step 313). This is because in the case of an existing user, there exists a user logo previously registered and stored.

In the case of an existing service user, a user logo previously registered and stored in the database is transmitted to the user (step 325). In the case of a new service user, it is checked whether the user has a logo to be used as a watermark (step 315). If he has no logo to be used, a logo is generated by using the logo generation tool 220 provided in the system of the present invention and then a process for storing the generated logo in the client 100 and DBMS 130 is performed (step 317). When a logo is generated, target data in which a watermark is embedded is imported (step 321).

In the embodiment of FIG. 3A, a step of embedding a watermark into the target data is performed by a user (step 323). Concerning the watermark embedding, there may be presumed a case which enables a user to select a watermarking method. For example, in case where each of the watermarking companies (A,B,C) is operated together in the MDCAS server 120, the user may select one method among a variety of watermarking methods. Of course, the operation may be performed in the MDCAS server 120 by providing each watermarking algorithm to the MDCAS server 120 by each company. Otherwise, by operating the watermarking algorithm by each company, each company may perform the watermarking and the MDCAS may purely perform the authentication of the copyright.

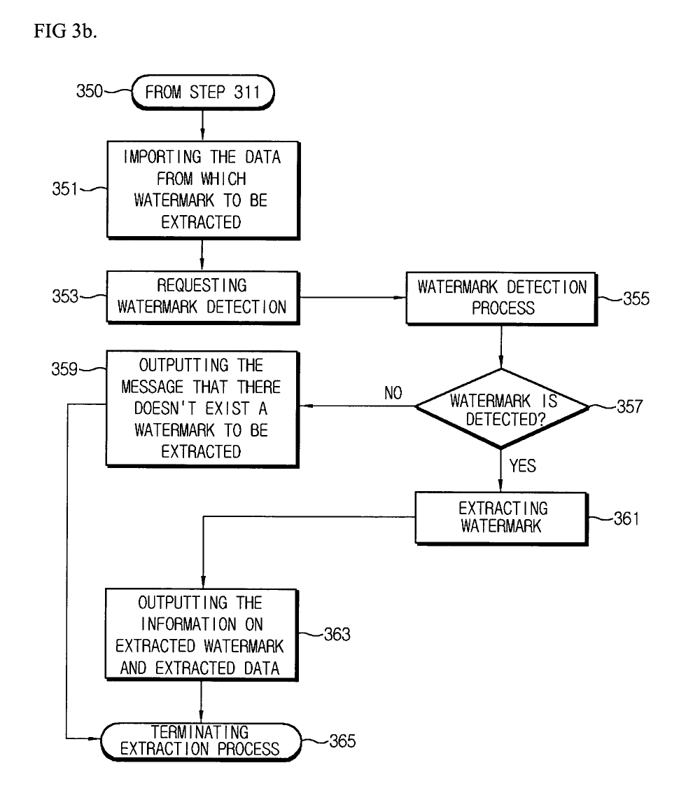

In the above case, as illustrated in FIG. 4, the user logs in the MDCAS server 120 and goes through a basic process as mentioned previously. Thereafter, the user selects one method among a variety of watermarking methods provided by the MDCAS server 120 (step 322), and then, embeds a watermark into data by using the selected watermarking method (step 323). Next, the embedded data and information thereof are stored and managed in the database within the database system 130 (step 326).

The watermark-embedded target data is transmitted back to a server of the certificate authority and the server stores the data received (step 327). Of course, in the step 327, it is judged whether the data to be stored is new data which needs to be newly stored. As a result, if the data is determined to be unnecessary, it is possible to omit them. Next, if a user outputs the watermark-embedded data and information on the watermark (step 329), the process of embedding a watermark is terminated (step 331).

In case that the operation judged from the step 309 is an extraction operation, the operation is performed according to the flow illustrated in FIG. 3B. During the extraction process, an objective data from which a watermark is to be extracted is imported (step 351). The user requests a watermark detection by transmitting the objective data to the server (step 353) and the server begins to perform a watermark detection process (step 355). The server detects whether there exists a watermark embedded during said process (step 357). If a watermark is detected, the watermark is extracted (step 361) and the server transmits user information about the extracted watermark and the extracted data to the user (step 363). However, if a watermark is not detected, a message to the effect that there does not exist a watermark to be extracted is outputted to the user (step 359), and the extraction process is terminated.

Briefly reviewing the foregoing process in which the user can select a watermarking method in connection with the extraction operation, as illustrated in FIG. 4, a user selects a company providing a watermark extraction method in a state that watermarked data are called (step 354). When the watermark extraction method is determined, a watermark is extracted from the corresponding data according to the determined method (step 355), and then, the authentication operation of the data is performed.

Also, in case where a watermark is embedded according to a watermarking method provided by MDCAS, not directly by a user, if it is necessary to authenticate multimedia data, information stored in the above MDCAS is called. Then, a watermark is extracted by using an extraction method of the same company that was selected when a watermark is first embedded. Thereafter, information about a series of copyright and content is authenticated from the extracted information.

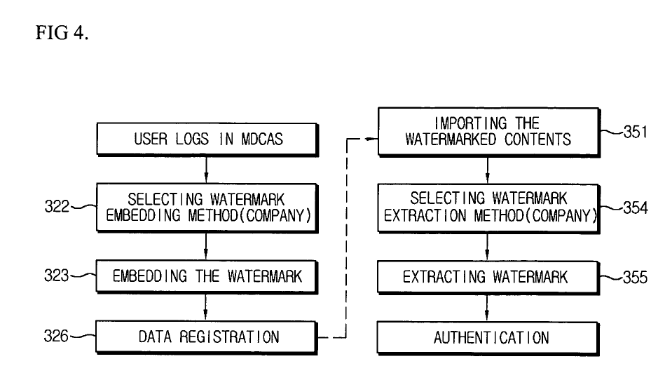

FIG. 5 illustrates a method that enables a user to directly embed a watermark and register the watermark-embedded content in MDCAS. In this case, the user does not use the MDCAS but embeds a watermark in the content by a free method and with a product, which the user desires. However, if the user registers the watermark-embedded content in MDCAS for authenticating the content, the user transmits information about the watermarking method used together with the content. That is, such information contains that by what technique and products of which company the watermarking method is performed. The MDCAS stores said information together with the content. If the user requests a series of authentication, then the MDCAS extracts a watermark by selecting a watermark extraction method of each company from said stored information and authenticates it.

In addition, although the flowcharts of FIGS. 3A and 3B do not display it, a user's itemized statement for payment is transmitted from the server to the payment gateway 140 whenever the above watermark embedding/extracting services are performed. Its calculated result is transmitted to the server 120, and again directly to the user 100 or after adding up the total according to a given period.

In summary, the MDCAS server 120 stores, manages and provides data in which copyright information such as information about a copyright holder, the original data, and the copyright holder's logo is embedded. The MDCAS server 120 may also play a role as a provider providing the content.

As noted above, the copyright authentication service of multimedia data is generally explained. Said service is variously applicable according to the kinds of users utilizing such service and the forms of service. Here, the users utilizing the service are copyright holders, copyright authentication users said as sellers who sell copyrighted material, and purchasers who purchase copyrighted materials as authenticated. In this case, during the authenticating process, a user certificate authority (CA) for authenticating a user and a multimedia authentication certificate authority (MACA) for authenticating a copyright of a copyright holder or a seller are involved. All users have their own private keys and receive certificates of authentication enclosing public keys from the user certificate authority (CA).

First, for the case that a copyright holder uses a service according to the present invention, one embodiment of a service process provided to the copyright holder will now be explained. The copyright holder encrypts his original data with his private key. The copyright holder accesses the MACA with his personal ID and requests the copyright authentication of his data. At this time, the copyright holder transmits the encrypted data and a certificate of authentication to the MACA. The MACA first requests the CA to identify the user identity process about the copyright holder.

The CA confirms the data requested and then authenticates a user, i.e., a copyright holder. After authentication, the MACA converts the encrypted data to the original data by using the public key of the transmitted certificate of authentication. The MDCAS server in MACA retrieves a logo and user information previously registered by the user from the database and generates a watermark after organizing the information of the copyright holder retrieved from the database. The copyright information is embedded into the watermark. The logo and personal information (name, identity number, etc.) of the copyright holder transmitted to the server from the database and the logo of other certificate authorities are first embedded into the watermark, and automatically, the date and time information is inserted. Such process is called organization.

A watermark generated in such a method is embedded into the original data. The watermark-embedded data are transmitted to the copyright holder together with the certificate of authentication issued by the MACA. The original data, the generated watermark-embedded data and the copyright information are stored in the database within the DBMS. Further, in case where such process is performed, an itemized payment statement thereof is transmitted to the payment gateway.

In this case, it is possible for the MACA to sometimes play a role as a user certificate authority (CA).

Next, in case where a user is a content seller, its service process is the same as that of the above process of a copyright holder. Since the seller has a duplication right of a relevant data copyright, he can be considered as being in the position of a copyright holder.

Finally, in case where a user is a content purchaser, the authentication process between the CA, MACA and user will be explained. First, a purchaser purchases a digital content after accessing a site providing the content. In this case, the site providing the digital content authenticates the purchaser by using encryption algorithm and then provides the content to the authenticated user only. Thus, the content provider plays a role as the CA which authenticates a user. The MACA for a digital data authentication service according to the present invention performs the copyright authentication, operating with a digital content providing site, which performs a user authentication.

In more detail, the content purchaser first accesses the content providing site and is authenticated as a user after going through a registration process such as becoming a member of the site. The content provider, i.e. the CA, transmits to the MACA information about the content requested by the user (kinds of content, etc.), information about the content provider himself, and information about the purchaser. At this time, such information is transmitted in an encryption form.

The MDCAS server in the MACA receives such information and requests information and a logo about the content provider registered in the database of DBMS. The MDCAS server receives the information and logo requested from the database, makes a watermark to be embedded into the original data, and then, embeds the watermark into the original content data. The watermark-embedded data is encrypted again and then transmitted to the CA, i.e., the content provider, together with the certificate of authentication of the MACA. At the same time, the original data, the watermark-embedded data, and the copyright information are stored in the database of MACA.

The content provider transmits to the purchaser the watermark-embedded data obtained from double-encryption of the received information by using a predetermined encryption method, which is agreed between a provider and purchaser. A right purchaser can obtain his desired content by using a double-encryption key previously provided by the content provider and encrypting the content.

In another embodiment of the present invention, watermark-embedded data may be transmitted directly to a purchaser, not to a content provider.

In such MACA-purchaser-CA (content provider) structure, in case that the MACA plays a role as a content seller, the function of the MACA and CA may be united into a single system.

In a process where the registration and authentication of a copyright using a watermarking system is performed, the present invention uses a new concept named “a copyright certificate authority” as above. The certificate authority is capable of copyright authentication as a third authority. Thus, it may be a single formal authority throughout the world and it may be established from a governmental point of view according to nations. Otherwise, an organization suitable for an establishment standard may be established according to a nongovernmental point of view so as to be authorized by a nation. In any case, since the internet is not confined to a national level but is a network spreaded throughout the whole world, a standard to be commonly used throughout the world is needed. Also, a certificate authority established suitable for such standard is needed and another higher organization is also needed to manage such certificate authority.

As above, in case that the authentication services of the same methods as those of FIGS. 4˜6 are performed, the different watermarking algorithm from each company may cause problems. As explained previously, since each of the watermarking methods is quite different from each other in their purposes and methods, it is not easy for the MDCAS to manage them. Thus, in order to settle such problems, the two-layer digital watermarking method is used. This method provides each of the watermarking methods themselves with their own indexes, thereby making it possible to recognize which watermarking method is used and extract again information about a pure copyright and content based on such obtained information, and thus, it is very useful.

Industrial Applicability

As suggested above, the third certificate authority based on a watermarking technique should be established between a digital content provider and a user using the digital content for the following reasons: If both embedding and extracting methods of a watermark are disclosed to the general public, the confidence of copyright authentication would be decreased, and thus the third organization is needed for preventing the general public from performing either of embedding or extracting.

In case where an illegal use of a content is sensed, evidencing the embedment of copyright information by a watermarking system has the following effects: Content owners hope that an embedded watermarking would be a basis for argument of the preservation of his copyright as well as indisputable evidence of his copyright retention. In this case, the original data, copyright holder information, and data about an extracted watermark registered in a certificate authority having public confidence would be indisputable evidence to assert the copyright owner's rights. Thus, in the event that there arise multimedia data copyright-related disputes, such embedded-watermarking would be an influential basis capable of evidencing a copyright of the original copyright holder with respect to data.

Also, in case where each individual performs the embedment and extraction of a watermarking, it is not compelled to impose charges on the performance of embedment and extraction of the watermarking in a general sale of software. However, as suggested in the present invention, if it goes through the third authority, it is easy to impose fixed charges on the performance of use and extraction of a watermark.

The target data into which a watermark is embedded can be extended to data needed for copyright protection or information security such as important digital documents of a company, individual or governmental offices as well as such digital multimedia content. That is, by embedding secret documents or information into the existing multimedia data as a watermark, it is possible to prevent illegal disclosure of information to persons who are not allowed to read them.

The multimedia data copyright authentication authority according to the present invention performs the authentication of a copyright about certain digital copyrighted material as well as is applicable to the transmission/receipt of important documents in the electronic business on the internet. That is, a watermarking technique authenticated by the certificate authority is not confined to the function of simply embedding and extracting information but applicable to data hiding. Thus, if multimedia data such as generally used images or audio data are transmitted after hiding important document content, information, etc. in the same method as a watermarking technique, it is possible to reduce dangerous matters, such as files being illegally stolen, without using an existing encryption transmission method.

While there has been described and illustrated embodiments for multimedia data copyright authentication services according to the present invention, it will be understood to those skilled in the art that all modifications and conversion shall be limited solely by the scope of the claims appended hereto:

What is claimed is:

1. A service system for supplying a copyrighted material, comprising:
a database for storing information about the copyrighted material; and
a copyrighted material supplying means for providing the copyrighted material, at a user's request through the internet to supply said copyrighted material, wherein said copyrighted material is received from said database and copyright information formed as a watermark is embedded into said copyright material.

2. A service system for supplying a copyrighted material, comprising:
a database for storing information about the copyrighted material; and
a copyrighted material supplying means for providing said copyright material, at a user's request through the internet to supply said copyrighted material, wherein the copyright information received from said database is embedded in a watermark form.

3. The service system for supplying the copyrighted material according to claim 1 or 2, wherein the transmission of data between said copyrighted material supplying means and said user is performed through a web browser.

4. The service system for supplying the copyrighted material according to any one of claims 1 to 3, wherein said watermark is embedded in an image form.

5. The service system for supplying the copyrighted material according to claim 4, wherein said copyright information includes information about a copyright holder and a copyright holder's logo.

6. The service system for supplying the copyrighted material according to claim 4, wherein a type of said watermark to be embedded is selected by said copyright holder.

7. The service system for supplying the copyrighted material according to claim 1, 2, 5 or 6, wherein said watermark is embedded utilizing a two-layer watermarking method.

8. The service system for supplying the copyrighted material according to claim 5 or 6, further comprising a logo generation means for generating a logo capable of indicating said copyright holder, wherein a logo generated by said logo generation means is stored in said database, via said copyrighted material supplying means, as said copyright information.

9. A service system for authenticating a copyrighted material, comprising:
a database for storing information about the copyrighted material; and
a copyrighted material authentication means for performing the authentication of the copyrighted material provided by a user, at said user's request through the internet to authenticate said copyrighted material, wherein a watermark is extracted from the copyrighted material received from said user; the extracted watermark is compared with information about said copyrighted material stored in said database; and the copyrighted material received from said user is authenticated.

10. The service system for authenticating the copyrighted material according to claim 9, wherein the transmission of data between said copyrighted material authentication means and said user is performed through a web browser.

11. The service system for authenticating the copyrighted material according to claim 9 or 10, wherein said watermark is embedded in an image form.

12. The service system for authenticating the copyrighted material according to claim 11, wherein said copyright information includes information about a copyright holder and a copyright holder's logo.

13. The service system for authenticating the copyrighted material according to claim 11, wherein kinds of said watermark to be extracted are selected by said copyright holder.

14. The service system for authenticating copyrighted material according to claim 9, is 10, 12, or 13, wherein said watermark is embedded utilizing a two-layer watermarking method.

15. A service method for supplying a copyrighted material, comprising the steps of:
registering a copyrighted material provided by a copyright holder through the internet and copyright information about said copyrighted material;
embedding said copyright information into said copyrighted material as a watermark at a user's request to provide a copyright with respect to said registered copyrighted material; and
providing said watermark-embedded copyrighted material to said user.

16. The service method for supplying the copyrighted material according to claim 15, wherein said watermark is embedded in an image form.

17. The service method for supplying the copyrighted material according to claim 16, wherein said copyright information includes information about a copyright holder and a copyright holder's logo.

18. The service method for supplying the copyrighted material according to claim 17, wherein a type of said watermark to be embedded is selected by said copyright holder.

19. The service method for supplying the copyrighted material according to any one of claims 15 to 18, wherein said watermark is embedded utilizing a two-layer watermarking method.

20. A service method for authenticating a copyrighted material, comprising the steps of:
receiving a copyrighted material at a user or copyright holder's request through the internet to authenticate the copyrighted material;
extracting a watermark from said received copyrighted material; and
transmitting the result of authentication to said user or copyright holder in comparison of the copyright information obtained from said extracted watermark with a stored copyrighted material and copyright information.

21. The service method for authenticating the copyrighted material, according to claim 20, wherein said watermark is embedded in an image form.

22. The service method for authenticating the copyrighted material, according to claim 21, wherein said copyright information includes information about a copyright holder and a copyright holder's logo.

23. The service system for authenticating the copyrighted material according to claim 21, wherein a type of said watermark to be extracted is selected by said copyright holder.

24. The service system for authenticating the copyrighted material according to claim 20, wherein said watermark is embedded utilizing a two-layer watermarking method.

25. A service system for transmitting and authenticating a copyrighted material, comprising:
a copyrighted material provider system which is operated by a provider of copyrighted material;
a database system for storing the copyrighted material provided by said provider of said copyrighted material;
a user system which is operated by a user; and
a server for authenticating the copyrighted material provided by and at a request of said copyrighted material provider and said user, and for providing the copyrighted material,
wherein said copyrighted material provider system is constructed in such a manner that the copyrighted material and copyright-related information for the copyright authentication are provided to said server so as to be stored in said database system;
said user system is constructed in such a manner that the copyrighted material stored in said database system is selected and displayed at the request of the transmission of a specific copyrighted material; and
said server transmits, respectively, the information about said copyrighted material and the information about said user, which are embedded as watermarks, at a request from said user system to transmit the copyrighted material, and the watermark embedded in said copyrighted material is extracted so as to authenticate a copyright by comparison of the extracted watermark with the copyright-related information stored in said database system at said copyrighted material provider's request or said user's request to authenticate the copyright of the copyrighted material.
